(19) United States
(12) Patent Application Publication
(10) Pub. No.: US 2009/0081628 A1
(43) Pub. Date: Mar. 26, 2009

(54) SYSTEM AND METHOD FOR CREATING A LESSON

(76) Inventors: Roy Leban, Redmond, CA (US); Daniel R. Kerns, Mercer Island, WA (US); Nigel J. Green, Bellevue, WA (US)

Correspondence Address: HAHN AND MOODLEY, LLP, P.O. BOX 52050, MINNEAPOLIS, MN, 55402, US

(21) Appl. No.: 11/860,430

(22) Filed: Sep. 24, 2007

(51) Int. Cl. G09B 3/00

(52) U.S. Cl. 434/350

(57) ABSTRACT

Embodiments of the present invention make it significantly easier for a teacher or other author to create a lesson by allowing them to define a lesson as a state machine. This method is significantly easier for teachers to learn and use and it allows for easy adaptation of classroom lesson plans to lessons in the system. Advantageously, someone with specialized programming knowledge is not required in the lesson creation process.

### FIELD

Embodiments of the invention relate generally to the field of education, and more specifically to the field of delivering educational content, including lessons, to students using technological means.

### BACKGROUND

Educational systems utilizing computers may be used to provide educational content to learners. Such educational content may include multimedia content rich in, e.g. sound, graphics, video, etc. to provide a compelling learning experience. The educational content may be packaged in the form of lessons comprising executable code that is delivered to a client computer which executes or plays the lessons. Lessons may be created using a procedural programming language, perhaps a domain specific language (DSL) specifically designed for the purpose. But, such a language, even with visual editing or other coding assistance is still a programming language, requiring the expertise of a programmer, rather than a teacher. Entire lessons must be written from start to finish, necessitating a great deal of manual work. Further, the reality is that teachers, in general, do not author lessons—they create lesson write-ups or outlines that are then turned into lessons by programmers.

### SUMMARY

Embodiments of the present invention make it significantly easier for a teacher or other author to create a lesson by allowing them to define a lesson as a state machine. This method is significantly easier for teachers to learn and use and it allows for easy adaptation of classroom lesson plans to lessons in the system. Advantageously, someone with specialized programming knowledge is not required in the lesson creation process.

Other aspects of the present invention will become apparent from the detailed description below.

### BRIEF DESCRIPTION OF THE DRAWINGS

While the appended claims set forth the features of the present invention with particularity, the invention, together with its objects and advantages, will he more readily appreciated from the following detailed description, taken in conjunction with the accompanying drawings, wherein:

FIG. 1 is an example of a lesson shown as a state diagram, in accordance with one embodiment of the invention.

FIG. 2A is an example of a lesson description shown in a text format, corresponding to the lesson of FIG. 1. FIGS. 2B-2D show examples of inherited lessons.

FIG. 3 is another example of a lesson shown as a state diagram, in accordance with one embodiment of the invention.

FIG. 4 shows a block diagram of the authoring system, in accordance with one embodiment of the invention.

FIG. 5 shows the process of authoring content in the authoring system, in accordance with one embodiment of the invention.

FIG. 6 shows a high-level block diagram of hardware that may be used to implement any of the systems, or server systems of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Although the following description contains many specifics for the purposes of illustration, one skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Throughout this description, the present invention will he described using terminology of computers, personal computers, and the Internet, along with terminology related to current educational methods and systems. However, one skilled in the art will appreciate that such terminology is intended to be non-limiting.

Embodiments of the present invention cover a lesson authoring method for authoring a lesson to be executed by a system defining a lesson execution platform. Embodiments of the present invention also cover a lesson authored in accordance with the lesson authoring method, and said system for executing said lesson.

In accordance with the lesson authoring method, a lesson is written or represented as a lesson state machine. The state machine may be a domain-specific type of state machine intended specifically for lessons, and may include additional general-purpose extensions which would make it easier to author a lesson in the form of a state machine.

Lessons as State Machines

A lesson authored in accordance with the method of the present invention may comprise a plurality of states, each representing a different situation that a student can be in. The lesson may specify how the lesson gets set up, what happens to set up each state, what happens when events occur, and how the student moves from state to state.

One way of depicting or representing a state machine is through a state machine diagram, commonly called a state diagram. The lessons of the present invention will be represented using state diagrams.

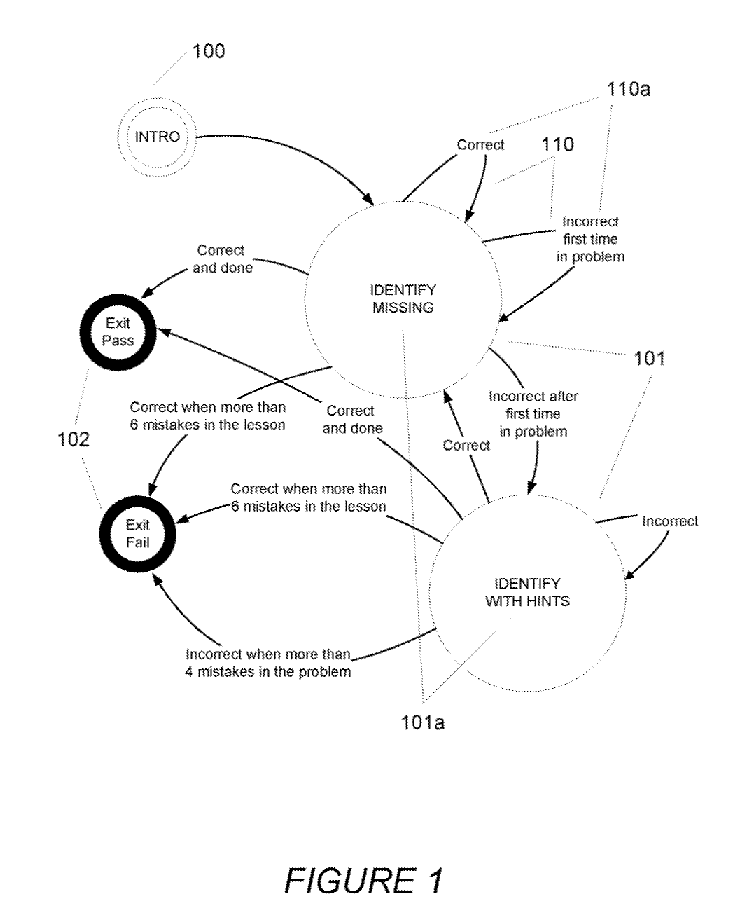

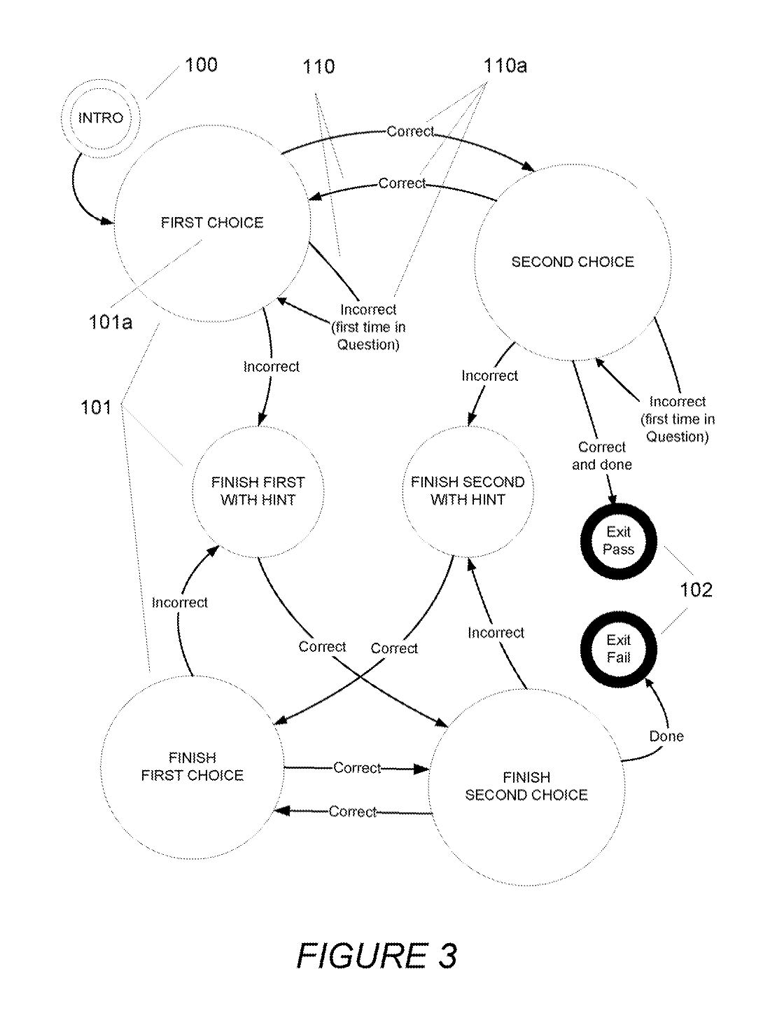

FIG. 1 and FIG. 3 show exemplary lessons, described or represented using state machines. It is important to note that the lessons of the present invention, when fully described, are state machines and may be run directly on a lesson execution platform. In other words, the lessons of the present invention are and thus exist as state machines prior to and independently of the execution of the lessons. The lessons comprise a number of states, including at least an intro state 100. Most state machines also include one or more regular states 101 and one or more exit states 102. In the most minimal lesson, the intro state would also be an exit state and the lesson would contain only one state. Each state may have one or more transitions 110. Each state in the state diagram has a description 101a or other explanatory information. Each transition in the state diagram has a description 110a or other explanatory information. Together, these descriptions convey the functional mechanism of the state machine. FIG. 1 and FIG. 3 also includes a tool specification 150, which lists the tools used in the lesson. Note that, for illustrative purposes, the exemplary figures omit some detail of how the lessons work within each state and transition, so FIG. 1, as shown is not a fully functioning lesson. Normally, the complete details of the functioning of the states and transitions would be included within the state and transition descriptions, although some embodiments may use other mechanisms for this detail, such as an auxiliary detail document. When the state diagram is combined with the additional detailed information, it may be run directly with no intermediate translation, within an appropriate execution environment.

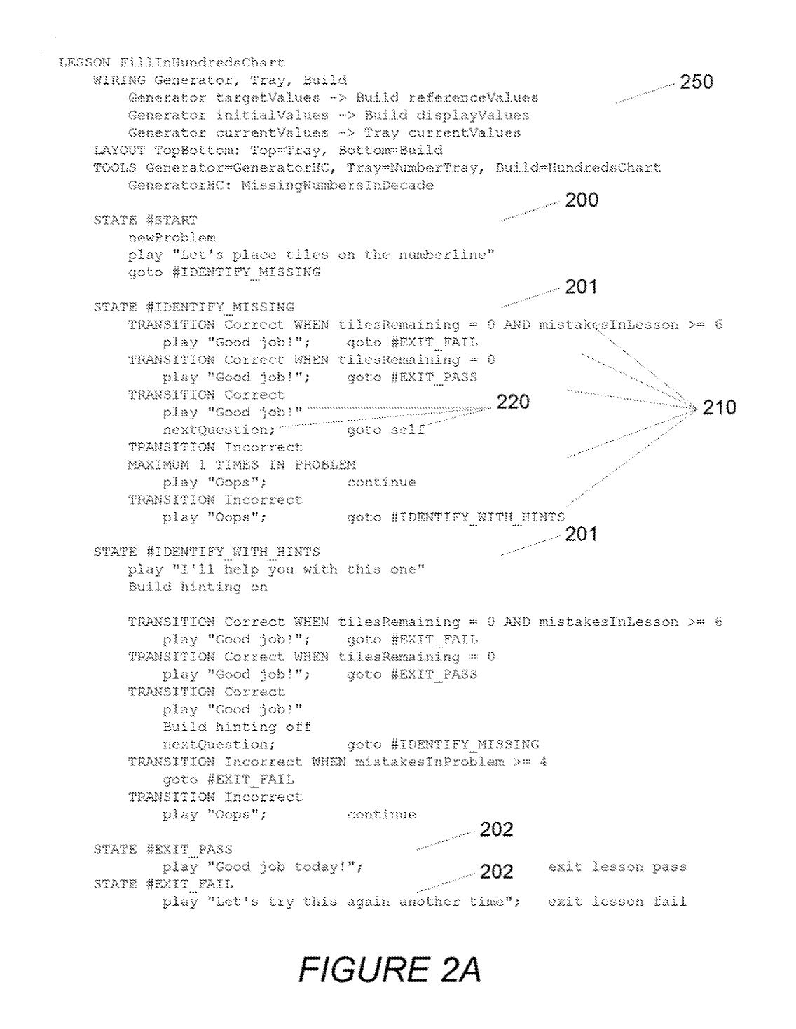

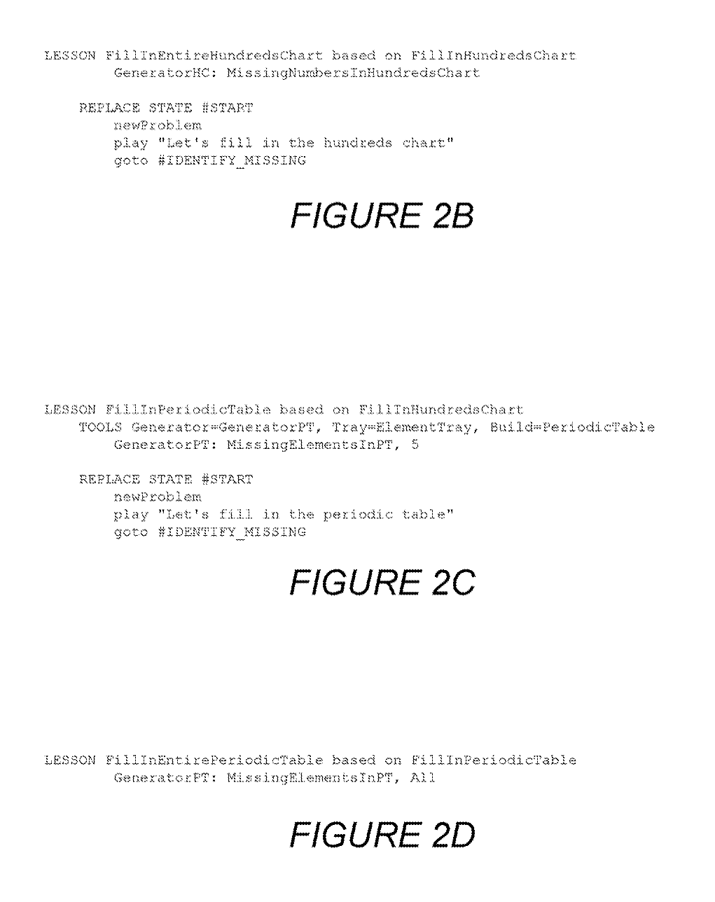

FIG. 2A shows an exemplary text specification for the lesson of FIG. 1. One skilled in the art will appreciate that the text specification is equivalent to the lesson of FIG. 1. Such a text specification contains an intro state specification 200 corresponding to a state 100, regular state specifications 201 corresponding to regular states 101, exit state specifications 202 corresponding to exit states 102, and transition specifications 210 corresponding to transitions 110. Each transition has one or more action specifications 220, corresponding, as a group within each state or transition specification, to the descriptions 101a and 110a. The text specification also includes a block 250 containing wiring, layout, and tools information, which is a superset of the tool specification 150.

In contrast with FIG. 1, FIG. 2A contains the additional detail omitted from FIG. 1, making it a fully runnable lesson in an appropriate execution environment.

If the additional detail of FIG. 2A were added to FIG. 1, both FIG. 1 and FIG. 2A would be fully running lessons (in fact, they would be the same lesson) without any need for programmer interaction. The same can be said of FIG. 3.

One skilled in the art will recognize that computer processors are, at their heart, state machines, that applications written for modern event-driven operating systems frequently function as state machines, and that most computer programs are translated into state machines by compilers. The present invention does not change any of that and, in fact, an embodiment of the invention may well make use of such processes.

In the present invention, it is the structure of lessons and the lesson development process which stand in marked contrast to prior art methods, in which the lesson development process involves both a teacher and a programmer, with the teacher writing the lesson as a text description and the programmer translating that lesson into a computer program which executes the lesson. Such a computer program might be written in a language such as C++, C#, or Java, or it might be written in a high level “authoring” language, but such an actual lesson must be written in programming terms, not teacher terms, in order to function, and any implementation of lesson states is part of the translation process, not a fundamental part of the lesson definition. Thus, in accordance with embodiments of the invention, no translation from teacher terms to programmer terms is necessary.

Embodiments of the present invention also stand in marked contrast to what might appropriately be called non-lessons, including such items as tests, random tests, and drill and practice routines. In such educational content, the lesson itself is almost non-existent, with tests, test questions, and drill items being pulled from a database or other data source.

Again, nothing prevents such prior art methods from being used, as an augmentation to the methods of the invention. For example, an embodiment of the invention might mechanically translate a lesson represented as a state machine into machine code or bytecode for more efficient execution, or to hide the state machine source when the state machine is executed on a client machine, in the same way that languages such as C# and Java are translated into bytecode for execution, or a processor might execute processor instructions using microcode.

Lesson Components

To better understand how lessons function in accordance with embodiments of the present invention, it is useful to describe the structure of a lesson, and one embodiment is described herein. The structure described in this and in the following sections is intended only to illustrate the present invention and to provide information for those wishing to practice the invention, not to impose limitations upon the invention.

Tools

Lessons may use one or more tools which provide the functionality needed in a lesson. Some tools are visible tools, such as a tool which displays a number, an abacus, a chart, a lever, or a chemical symbol. Other tools are invisible, such as a tool which performs a mathematical calculation or generates problems of a particular type. Each tool supports one or more interfaces which specify how the lesson interacts for a tool, with other tools, and with the client runtime environment. In one embodiment, an interface is a named set of actions that a tool supports, values that it makes available to a lesson, and events that it provides to the lesson. For example, a tool may have a DisplayNumber interface that might specify that the tool can be given a number to display and that the tool can be highlighted. A SelectableNumber interface might specify that the tool can do everything that the DisplayNumber interface specifies, plus it can be selected and trigger an event for the lesson that it was selected or deselected. A BuildNumber interface might specify that a tool can allow a student to build a number or a representation of a number (e.g., by typing, or drawing a figure), and that the tool can provide the value of the built number to the lesson.

In one embodiment, the lessons of the present invention may include one or more of the following tools:

GeneratorHC (or GeneratorHundredsCharts) generates problems for a lesson involving a hundreds chart used in elementary math. It supports one or more interfaces related to the values that it generates and provides a number of values to the lesson.

NumberTray displays one or more numbers that the student can drag to another tool. It supports one or more interfaces related to providing numbers for a student to use in a lesson.

HundredsChart displays a standard “hundreds chart” which may be fully or partially populated, in the latter case allowing the student to add numbers to it, for example by dragging them from a NumberTray.

These exemplary tools are used in the examples of FIG. 1 and FIG. 2A. FIG. 2A shows an exemplary tool specification, repeated herein for illustrative purposes:
TOOLS Generator=GeneratorHC, Tray=NumberTray, Build=HundredsChart
   GeneratorHC: MissingNumbersInDecade

In this tool specification and in accordance with the wiring model for the lesson (see below), a GeneratorHC tool goes in a Generator slot, the NumberTray tool goes in a Tray slot and the HundredsChart goes in a Build slot. Additionally, the GeneratorHC is set up with the MissingNumbersInDecade option.

Generators

Generators are a special type of invisible tool. A lesson may have zero or more generators. As in the GeneratorHC example above, a generator tool generates problems for a lesson. The generator tool is built independently of lessons and used in lessons, allowing greater productivity in the writing of lessons.

Choosers

Choosers, also called random property choosers, are a special type of invisible tool. A lesson may have zero or more choosers. Choosers may be used to randomly select lesson elements such as problems and tools. By way of example a chooser may be used to pick from different types of problems, different tools to activate, or any other lesson differentiator involving random choice. A chooser is declared by specifying the name of the chooser and the options it is to choose from, along with associated weights for those options. Choosers may choose a single value at a time or a series of values at a time.

For example, a chooser might randomly select between “Addition” and “Subtraction”, “Plus” and “Minus”, or “+” and “−” allowing a lesson to alternate between addition and subtraction problems.

Wiring Models and Layouts

A feature of embodiments of the present invention is the ability to composite or author a lesson from one or more tools combined with a wiring model. Much like a wiring diagram for an electrical circuit, a wiring model specifies how tools in the lesson are connected to one another. But, unlike a wiring diagram, the wiring model is used directly by the system to connect the tools.

Slot Declaration

A wiring model specifies a set of slots for tools, where each slot supports a tool that supports at least a particular interface, along with an optional wiring specification (also called a “wiring”) for how the tools are connected to one another. Thus, tools can only be placed in slots if they support the interface required by the slot. For example, a wiring model might specify that a particular output from a first tool is to be connected to a particular input to a second tool, so that whenever the first tool's output changes, the changed value is automatically delivered to the input of the second tool. For example, an output from a problem generator tool may be wired to an input of a display tool. A wiring model may extend another wiring model.

FIG. 2A shows an exemplary wiring model, repeated herein for illustrative purposes.
WIRING Generator, Tray, Build
   Generator target Values→Build reference values
   Generator initial Values→Build display Values
   Generator current Values→Tray current Values

The above wiring model specifies three slots for tools. These slots includes a Generator slot, a Tray slot; and a Build slot. In the above wiring model, the Generator has three outputs: targetValues, initialValues, and currentValues. In terms of the wiring, when a new problem is asked for, the Generator generates a new problem which contains targetValues, initialValues, and currentValues, and then automatically provides those values to the other specified tools, as will be described.

In the exemplary lessons of FIG. 1, FIG. 2A. FIG. 2B, the generator GeneratorHC would generate appropriate problem values for a hundreds chart problem for each problem in the lesson. For example, for each problem, the targetValues would be the values that appear in all or a portion of a hundreds chart (e.g. the numbers 21 to 30), the initialValues would be the values initially shown to the student (e.g. the numbers 24 and 27), and the currentValues would be the values the student is asked to place in the current problem (e.g., 25 and 26).

Through the wiring, these values are made accessible to the various tools. The Build tool receives a set of referenceValues, which are a reference of what is expected and a set of displayValues to display; the Tray tool receives a set of currentValues to provide to the student for the current problem.

In contrast, in the exemplary lessons of FIG. 2C and FIG. 2D, the GeneratorPT would generate appropriate problem values for a periodic table problem for each problem in the lesson. For example, for each problem, the targetValues would be the values that appear in all or a portion of a periodic table (e.g., the elements from Hydrogen to Roentgenium), the initialValues would be the values initially shown to the student (e.g., Antimony, Arsenic, Aluminum, and Selenium), and the currentValues would be the values the student is asked to place in the current problem (e.g.. Hydrogen, Oxygen, Nitrogen, and Rhenium). As described previously, the Build and Tray tools receive these values and present the problem to the student.

In one embodiment, a wiring model may be specified by a lesson author who writes the wiring model from scratch. In an alternative embodiment, a lesson authoring system may provide a lesson author with a number of predefined wiring models that can be specified or selected by the lesson author as part of the lesson authoring process.

The above wiring specifies that the lesson has three slots, namely a Generator slot, a Tray slot, and a Build slot. The GeneratorHC tool goes in the Generator slot, the NumberTray tool goes in the tray slot and the HundredsChart goes in the Build slot.

In this wiring, the Generator has three outputs: targetValues, initialValues, and currentValues. When a new problem is asked for, the Generator generates a new problem which contains targetValues, initialValues, and currentValues, and then automatically provides those values to the other specified tools.

Screen Layout Declaration

In one embodiment, each wiring model may include one or more screen layouts associated with it. The screen layouts specify the visual layout of the tools on the screen, including which slots are visible and which are hidden, and the positioning and orientation of any visible slots. Different wiring models may have corresponding screen layouts, which enables inherited lessons to substitute tools, wiring, and layouts. For example, some tools might need a vertical layout while other tools need a horizontal layout.

FIG. 2A shows an exemplary layout, specification, repeated herein for illustrative purposes.
LAYOUT TopBottom: Top=Tray, Bottom=Build

In this layout specification, a layout with a slot on top and a slot on bottom is requested, with the top slot being the Tray slot and the bottom slot being the Build slot. Any other tools, such as the Generator of FIG. 2A, are invisible.

In one embodiment, a layout is mapped to a fixed screen position, wherein each slot has an XY position, along with a width and height. In another embodiment, such screen positions might be chosen or modified based on external data, including, but not limited to student preferences, and student profile data.

Inheritance

Inheritance allows lessons to be based on other lessons. A lesson built on another lesson is called a derived or inherited lesson. The lesson it is based on is referred to as a base lesson. In one embodiment, an inherited lesson also contains a specification of a lesson to inherit from and may omit certain elements which are inherited from that lesson. Different embodiments may define inheritance differently. In one embodiment, any or all lesson declarations, tools, and states may be inherited and/or overridden.

Inheritance also allows states to be based on other states. A state built on another state is called a derived state. The state it is based on is considered the base state. Different embodiments may define inheritance differently In one embodiment, state actions, state transitions, and state parameters may be inherited and/or overridden.

Additional details of inheritance are provided in the following sections.

A non-inherited lesson may comprise a description; declarations for how the lesson is setup and what tools it uses, including lesson-wide settings, tool wiring and layout declarations; one or more tools, each of which has appropriate configuration options; and one or more states, each consisting of optional introductory actions, and one or more transitions, wherein each transition has an event which triggers the transition, an optional condition to test to determine if the transition is to be used, and one or more actions to perform when the transition is taken.

In one embodiment, a lesson also includes zero or more requirements for students to enter the lesson; and one or more assessments to evaluate the student when they exit the lesson. Lesson requirements and assessments are described more fully later.

In one embodiment, a lesson also includes test cases for validating that the lesson runs correctly. In one embodiment, test cases might specify lists of simulated input to provide to the lesson in order to validate it, or might specify a way to generate simulated input, such as instructions to get a certain number of problems correct or incorrect in a particular sequence.

Some of these elements can be seen within the sections of FIG. 2A, but one skilled in the art will appreciate how the remainder can be added.

An inherited lesson may specify override options for an existing tool, or it may completely replace the tool in the slot. Each tool can also have initial options set for it. While a slot may only have a single tool in it, it is possible to replace the tool in a slot during execution of a lesson. This might be useful, for example, if you want to present the same problem using more than one tool.

FIG. 2B, FIG. 2C, and FIG. 2D show exemplary inherited lessons.

In FIG. 2B, the FillInEntireHundredsChart lesson is based on the FillInHundredsChart lesson of FIG. 2A, with two changes: an instruction to the generator to generate different types of problems, and a replacement for the introduction.

In FIG. 2C, the FillInPeriodicTable lesson is based on the same FillInHundredsChart lesson of FIG. 2A, with two changes: a set of replacement tools for periodic table problems, and replacement for the introduction.

In FIG. 2D, the FillInEntirePeriodicTable is based on the FillInPeriodicTable lesson of FIG. 2C, with one change: an instruction to the generator to generate a different set of problems.

As can be seen, through the wiring models and a specification of which tools go in which slots, a lesson may be written without reference to specific tools and the same lesson logic can work for multiple lessons as inherited lessons, possibly with different subject matter, with minor changes via overrides.

States

A derived lesson may inherit states from the base lesson and can add additional states. In one embodiment, a derived lesson inherits all states and, if the derived lesson defines a state which has the same name as a base lesson state, it completely replaces that state—it does not extend it. The lesson author may be required to explicitly declare such a replacement of a state.

A state can extend another state, which means it inherits transitions and, optionally, the introductory actions from the base lesson. The base state may be any of the states in the complete lesson. For example, a derived lesson state may extend a base lesson state and a base lesson state may extend a derived lesson state. Some embodiments may choose to place restrictions on state inheritance. The lesson author may be required to explicitly declare such an extension of a state.

State Options

Another feature of the present invention is the ability to specify named related states. In one embodiment, named Next and Previous states are provided. These optional specifications allow state transitions which may be embedded within the contents of a state, but overridden in a derived state. This enables flexible derived states to be constructed easily. All states have an implicit named related state of Self, which is the state itself.

Each state can also specify a screen layout. If a state specifies a layout, that layout is shown when the state is entered. The layout will continue to be shown through all subsequent activities until another state is entered which specifies a layout. When using layouts specified in states, states which exist solely for transitional purposes will normally not specify a layout.

First Time Actions

The first time actions are actions which are executed the first time a state is entered within a lesson. In one embodiment, if a state has no first time actions, it inherits the first time actions of the base state, but such inheritance can be prevented by a state option.

Introductory Actions

The introductory actions are actions which are executed whenever the state is entered. The state is entered when a Goto is executed with the state as a target, or, in the case of the start state, when the lesson is started. In one embodiment, if a state has no introductory actions, it inherits the introductory actions of the base state, but such inheritance can be prevented by a state option.

Transitions

Transitions specify the actions that can happen within a state. Each transition specifies the conditions under which it is taken and a set of actions to take when it is taken. Transitions may optionally specify a new state to be entered after the transition is completed, with the new state specified either explicitly or as a named related state, such as Next and Previous as mentioned earlier. In one embodiment, transitions are based on high-level events which occur in the lesson (such as the student being correct), combined with conditions that are tested. Events include, but are not limited to, actions by the student, the result of an action by the student, and inaction by the student.

In one embodiment, a lesson of the present invention may support some or all of the following events: a

Correct Event: The student has taken an action to end the problem, such as clicking a Done button, and they have the problem correct. A student can be correct in a non-optimal way. This can be tested for with a condition.

Incorrect Event: The student has taken action to end the problem, such as clicking a Done button, and they have the answer incorrect. The student can be incorrect for a number of different reasons, which can be tested for with a condition.

Stalled Event: The student is not making forward progress. The student can be stalled because they are inactive (they do not appear to be doing anything), because they are indecisive (they are doing things in the lesson, but they are not doing whatever is necessary to end the problem), they have asked for too much help.

MaxProblemsReached Event: The student has reached the maximum number of problems. This event occurs when a NewProblem is done and the maximum number of problems for the state has been reached.

Transitions can also have test conditions, which are logical formulas which test properties of tools, including those that reflect how the student is currently doing.

Events and conditions can occur to trigger different transitions. Thus, in one embodiment, the transitions in a state are ordered so that when more than one transition applies, the earlier-ordered transition takes precedence. It is possible for an event to occur for which no transition is taken.

A transition may optionally have a limit, which specifies that it will be taken, at most, a specified number of times in the designated context or contexts. A transition may have a limit within the currently running lesson, within the current state, since it was last entered from another state, and within the current problem, or some combination.

In a derived state, transitions of the derived state normally take precedence over transitions of the base state. However, any transition may be specified as appearing at any place in the precedence order, described above. One embodiment uses labels to specify precedence, but a number of other techniques may be used as well. It is important to note that transition inheritance and transition ordering are independent.

Like a state, each transition has a series of actions that are executed when the transition is taken.

Actions

Each tool used in a lesson can also define actions which may be used in a lesson that uses that tool. For example, a tool may support highlighting, animation, or any other effect useful to teaching a student in a lesson. Like any programming or development system, an embodiment of the invention could support any number of prior art programming constructs, such as functions, procedures, calls, functional statements, loops, and conditional and selection blocks. However, the present invention also includes the novel actions described below that may be used within a lesson.

Activate Action

The Activate action is used to activate a particular tool in a slot. This allows a single lesson with a single wiring model to use a multitude of tools for different purposes.

NewProblem Action

The NewProblem action is used to present a new problem to the student. The manner in which the problem is generated depends on the problem generator used in the lesson. Frequently, the problem generator generates a random problem. When a new problem is presented to the student, all appropriate tools are updated to reflect the new problem.

With NewProblem, the lesson may optionally specify information about how the particular problem being generated is used in assessments, to allow assessments to differentiate between problems of different types within lessons that have multiple types of problems.

This differentiation may be of any type, so long as the lesson and the lesson assessments use the same taxonomy.

NextQuestion Action

The NextQuestion action is used to present a second or subsequent question (also called a follow-up question) about an existing problem. A single problem may have any number of such questions, including zero. A given question may omit follow-up questions, either because of the nature of the problem or because of the response of the student (such as because the student was correct or incorrect or because they gave a particular response or answered in a particular manner). With each question, the lesson optionally specifies the same information as described above about the question which may be used in assessments.

SampleProblem Action

The SampleProblem action creates a problem, just like NewProblem, but the problem, and any interaction with the problem by the user, is not recorded as a problem presented to the user.

Exit Lesson Action

The Exit Lesson action causes the lesson to stop. Every lesson is required to have at least one Exit Lesson statement.

Lesson Authoring Method

Lessons of the present invention are authored to be state machines, as described above. Thus, the lessons exist as state machines, independently of any execution of the lessons. In accordance with one embodiment, the process of authoring a lesson comprises outlining the lesson in terms of states of a state machine; and then defining the state transitions that can occur during execution of the stale machine. Advantageously, no programming skills are required in the process of authoring a lesson. Thus, a non-technical person such as a schoolteacher may author a lesson using the techniques of the present invention. In one embodiment, the lesson may be outlined as a state machine on paper, or using a word processor and then input into an authoring system. In one embodiment, an authoring system may be provided comprising a tool to facilitate the authoring of lessons as state machines. For example, the authoring system may have a graphical interface to support the description of lessons as state machines in terms of state diagrams. In an alternate embodiment, the authoring system might use a text editing interface to support the description of lessons as state machines in terms of text descriptions.

Embodiments of the present invention also disclose a lesson authoring method comprising selecting a wiring model for a lesson, the wiring model comprising at least one slot for a predefined tool; and assigning a predefined tool to each slot in the wiring model. In one embodiment, the wiring model may comprise a wiring specification that defines how the predefined tools in each slot are connected.

Authoring Lessons in the System

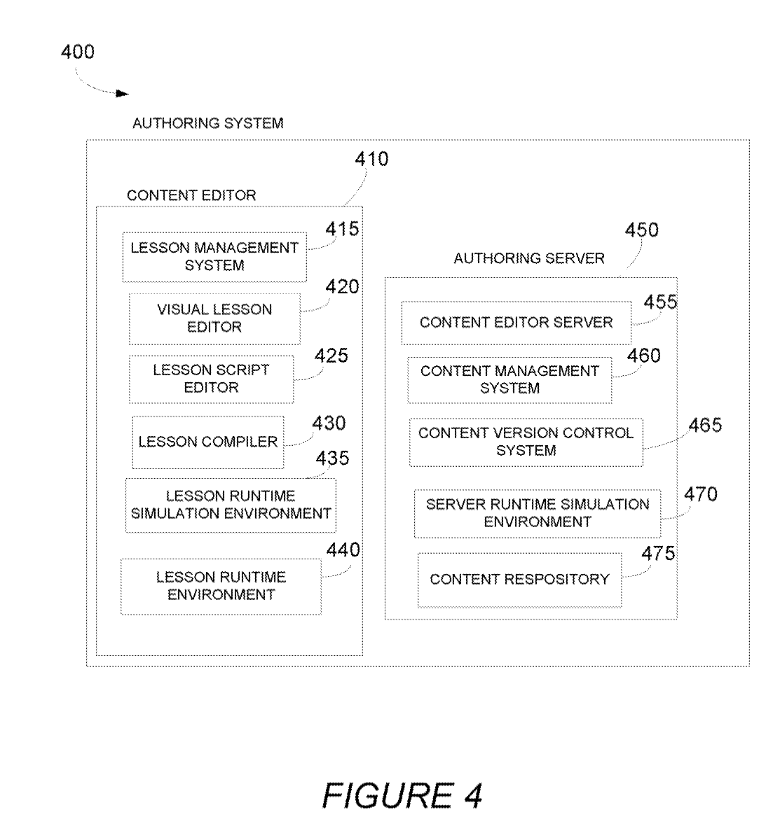

FIG. 4 shows an Authoring System 400, in accordance with one embodiment of the invention, which allows educators and other people to create or author educational content. In one embodiment, the Authoring System 400 may be deployed as a set of development tools for authors, including, but not limited to, visual design tools, editors, project management software, workflow management fools, source code control tools, bug tracking fools, and compilers. The Authoring System 400 comprises at least one content editor 410 for deployment on at least one client machine, combined with at least one authoring server 450. The content editor comprises at least one of a lesson management system 415, visual lesson editor 420, a lesson script editor 425, a lesson compiler 430, a lesson runtime simulation environment 435, and a lesson runtime environment 440. The components of the content editor connect, either individually or as a group, to the authoring server, which comprises at least one of a content editor server 455, a content management system 460, a content version control system 465, a server runtime simulation environment 470, and a content repository 475.

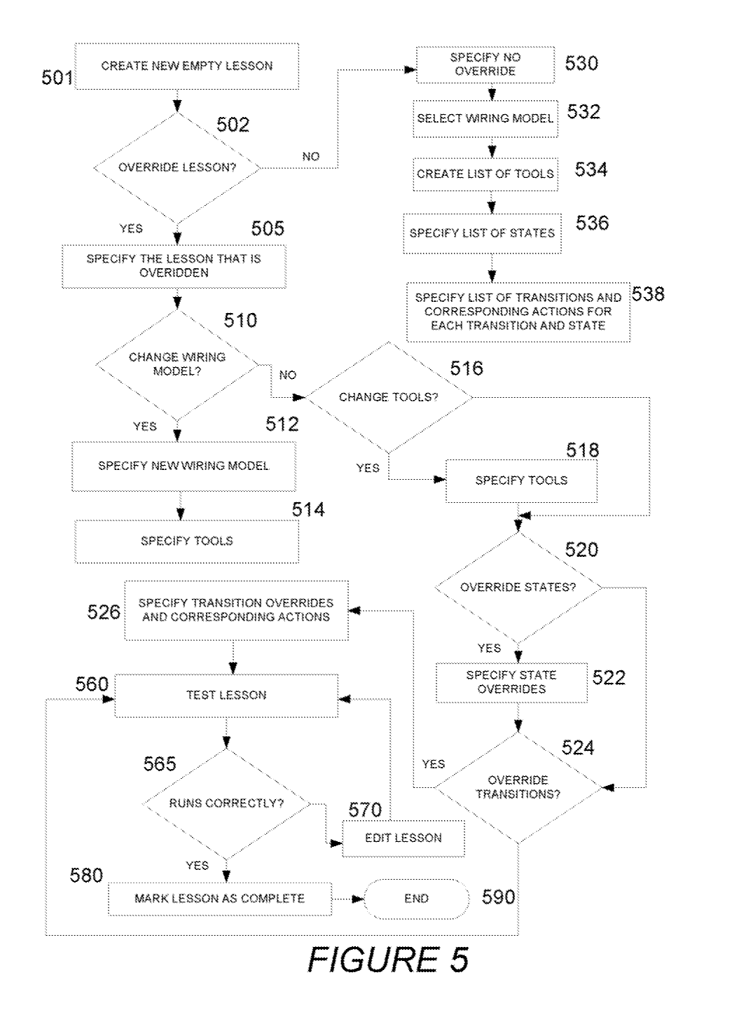

FIG. 5 shows an exemplary process of authoring content in the system. In step 501, the author creates a new empty lesson. In step 502, the author determines if the lesson can be built as an override of an existing lesson, meaning that it is sufficiently similar to an existing lesson such that only the differences may be specified. If this is the case, the process proceeds to step 505; otherwise, the process proceeds to step 530. In step 505, the author specifies the lesson that the lesson being built overrides. In step 510, the author determines if the wiring model needs to be changed. If so, the author specifies a new wiring model in step 512 and the appropriate tools in step 514. Otherwise, processing proceeds at step 516, where the author determine if any tools needs to be changed in the existing wiring model. If so, the author specifies them in step 518. In step 520, the author determines if any states need to be overridden. If so, the author specifies the state overrides in step 522. In step 524, the author determines if any transitions in non-overridden states need to be overridden. If so, the author specifies the transition overrides and the corresponding actions for each transition in step 526. Processing then proceeds to step 560. In step 530, the author specifies that the lesson does not override an existing lesson. In step 532, the author selects a wiring model for the lesson. In step 534, the author creates a list of tools to be used in the lesson. In step 536, the author specifies a list of states. In step 538, the use specifies a list of transitions and the corresponding actions for each transition for each state. In step 560, the author tests the lesson by running it and determines if the lesson is running correctly in step 565. If problems are found, in step 570, the author edits the lesson, changing states, transitions, and/or actions as appropriate, returning to step 560 for further tests. If no problems are found, the process proceeds to step 580, where the author marks the lesson as complete in the system. The process terminates in step 590.

In an alternate process, the author might first create a complete state diagram, either within the system or using a different mechanism such as pencil and paper, and then later enter the lesson into the system in a manner consistent with such a state diagram.

Hardware

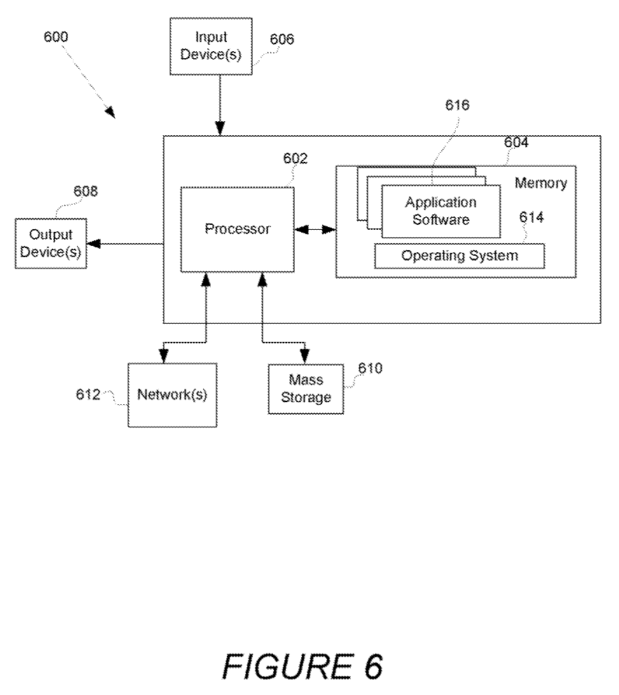

FIG. 6 of the drawings shows an example of hardware 600 that may be used to implement the authoring system 400, in accordance with one embodiment of the invention. The hardware 600 typically includes at least one processor 602 coupled to a memory 604. The processor 602 may represent one or more processors (e.g., microprocessors), and the memory 604 may represent random access memory (RAM) devices comprising a main storage of the hardware 600, as well as any supplemental levels of memory e.g., cache memories, non-volatile or back-up memories (e.g. programmable or flash memories), read-only memories, etc. In addition, the memory 604 may be considered to include memory storage physically located elsewhere in the hardware 600, e.g. any cache memory in the processor 602 as well as any storage capacity used as a virtual memory, e.g., as stored on amass storage device 610.

The hardware 600 also typically receives a number of inputs and outputs for communicating information externally. For interface with a user or operator, the hardware 600 may include one or more user input devices 606 (e.g., a keyboard, a mouse, heart rate monitor, camera, etc.) and a one or more output devices 608 (e.g., a Liquid Crystal Display (LCD) panel, a sound playback device (speaker), a haptic device, e.g. in the form of a braille output device).

For additional storage, the hardware 600 may also include one or more mass storage devices 910, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 600 may include an interface with one or more networks 612 (e.g., a local area network (LAN), a wide area network (WAN), a wireless network, and/or the Internet among others) to permit the communication of information with other computers coupled to the networks. It should be appreciated that the hardware 600 typically includes suitable analog and/or digital interfaces between the processor 602 and each of the components 604, 606, 608, and 612 as is well known in the art

The hardware 600 operates under the control of an operating system 614, and executes various computer software applications, components, programs, objects, modules, etc. to implement the techniques described above. Moreover, various applications, components, programs, objects, etc., collectively indicated by reference 616 in FIG. 6, may also execute on one or more processors in another computer coupled to the hardware 600 via a network 612, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

1. A method, comprising:
creating a lesson for execution on a lesson execution platform, the lesson defining a state machine that exists independently of an execution of the lesson by the lesson execution platform.

2. The method of claim 1, wherein the state machine comprises lesson states with predefined actions associated with each lesson state, and state transitions to control transitioning of the state machine between states based on events.

3. A method, comprising: representing a lesson as a state machine, prior to execution of the lesson, comprising
defining a sequence of lesson states;
defining a plurality of state transitions to control switching of the state machine between the lesson states; and
defining a plurality of events to control which state transition to take, wherein the state machine remains in a particular lesson state until a state transition is taken.

4. The method of claim 3, wherein each event is selected from the group consisting of a correct event which occurs when a student is determined to be correct, an incorrect event which occurs when a student is determined to be incorrect, a stalled event which occurs when a student's progress is determined to be inadequate, and a threshold event which occurs when a particular action has occurred a threshold number of times during execution in a particular lesson state.

5. The method of claim 4, wherein representing the lesson as a state machine comprises defining the lesson as an inherited lesson in which at least some of its attributes are inherited from a base lesson.

6. The method of claim 3, wherein defining the lesson states comprises defining a lesson state as an inherited state in which at least some of its attributes are inherited from a base state.

7. The method of claim 3, wherein execution within a lesson state is based upon predefined tools.

8. The method of claim 7, further comprising selecting the predefined tools for each lesson state; and specifying a wiring model comprising slots to which the predefined tools are assigned.

9. The method of claim 8, wherein one of the tools is a choosing tool that allows random selection of a lesson element.

10. The method of claim 9, wherein the lesson element is selected from the group consisting of a problem type, and a predefined tool.

11. The method of claim 8, wherein one of the predefined tools comprises a question-generating tool for generating questions based on a problem, each question being of a certain type, wherein said tool randomly selects the questions based on type.

12. The method of claim 3, wherein the state transitions have an order and wherein for a given event, the state transitions are evaluated sequentially in said order to determine which state transition to take.

13. The method of claim 12, wherein the order is implicit in the spatial location of the state transitions in the representation of the state machine.

14. The method of claim 3, wherein the representing is performed using a high-level language comprising primitives corresponding to a state and a state transition, respectively.

15. The method of claim 3, wherein the representing is perform in a graphical editing environment that supports operations to create and edit states and state transitions.

16. A method, comprising:
deciding on a lesson; and
defining the lesson comprising
specifying a wiring model for the lesson wiring model comprising at least one slot for a predefined tool; and
assigning a predefined tool to each slot in the wiring model.

17. The method of claim 16, wherein the wiring model comprises a wiring specification that defines how the predefined tools in each slot are connected.

18. The method of claim 16, wherein each slot defines an interface that the particular predefined tool assigned to that slot must support.

19. The method of claim 16, wherein the predefined tool comprises a problem generating tool.

20. The method of claim 16, wherein the predefined tool comprises a choosing tool that allows random selection of a lesson differentiator.

21. A system, comprising:
at least one lesson defining a first state machine whose existence is independent of an execution of the lesson by the system; and
a lesson execution engine to execute the at least one lesson; wherein the lesson execution engine implements a second state machine, based on its architecture, for executing the lesson.

21. The system of claim 20, wherein the first state machine comprises (a) at least one lesson state, each having particular inputs and outputs, (b) a plurality of state transitions to control switching of the state machine between the lesson states; and (c) a plurality of events to control which state transition to take, wherein the state machine remains in a particular lesson state until a state transition is taken.

23. A computer-readable medium, comprising:
instructions defining a lesson for execution on a lesson execution platform; wherein the lesson defines a state machine independently of the lesson execution platform.

24. The computer-readable medium of claim 23, wherein the state machine comprises lesson states with predefined actions associated with each lesson state, and state transitions to control transitioning of the state machine between states based on events.
